(19) United States
(12) Patent Application Publication
(10) Pub. No.: US 2011/0185537 A1
(43) Pub. Date: Aug. 4, 2011

(54) Vehicle Floor Mat Securing Apparatus

(76) Inventor: Jess R. WINTERS, Bakersfield, CA (US)

(21) Appl. No.: 13/020,725

(22) Filed: Feb. 3, 2011

Related U.S. Application Data
(60) Provisional application No. 61/301,092, filed on Feb. 3, 2010.

(51) Int. Cl. B60N 3/04

(52) U.S. Cl. 16/4

(57) ABSTRACT

A floor mat mounting system using a pair of brackets for securing floor mats directly to the mounting ear of the seat tracks. The brackets are form fitted to the size of the car and securely hold the floor mats to prevent shifting for maximum coverage of the car floor from dirt and grime.

The current application claims a priority to the U.S. Provisional Patent application Ser. No. 61/301,092 filed on Feb. 03, 2010.

### FIELD OF THE INVENTION

The present invention relates generally to a system for securing and locking a vehicle's floor mats to prevent moving and sliding.

### BACKGROUND OF THE INVENTION

The purpose of the floor mat of a car is to act as a barrier for dirt and grime from contaminating the car. Due to its removability, the floor mat can be taken out of the car to be washed. By providing a removable barrier, the user is able to keep the interior of the car free from dirt and grime brought in by the user's shoes. However, in many cases, the floor mat easily shifts inside of the car. Although, the floor mat shifting around the floor of the car is still able to act as a barrier, the shifting allows some of the dirt to slip under onto the floor. The present invention overcomes such a problem by introducing a floor mat securing mechanism that ensures that the floor mat remains in place. The present invention locks the driver's and/or passenger's floor mats into a set position and will not allow the floor mats to move or slide forward into an unsafe position. The present invention prevents the throttle pedal from possibly getting stuck by keeping the driver's floor mar from sliding forward and bunching up under the throttle pedal. The present invention is securely attached to the mounting ears of the driver's and/or passenger's seat tracks which are located under the seat frame.

### BRIEF DESCRIPTION OF THE DRAWINGS

FIG. 1 is a exploded view of the bracket, the mat washer, and the threaded bolt of the present invention.

FIG. 2 is a cross sectional view of the bracket, mat washer, and the threaded bolt assembly.

FIG. 3 is an exploded view of the embodiment of the present invention with the horizontal fastening bar.

FIG. 4 is a perspective view of the embodiment of the present invention with the horizontal fastening bar.

FIG. 5 is a perspective view of the embodiment of the present invention with the horizontal fastening bar in its environment.

FIG. 6 is a perspective view of the embodiment of the present invention with the mat washers in its environment.

### DETAIL DESCRIPTIONS OF THE INVENTION

All illustrations of the drawings are for the purpose of describing selected versions of the present invention and are not intended to limit the scope of the present invention.

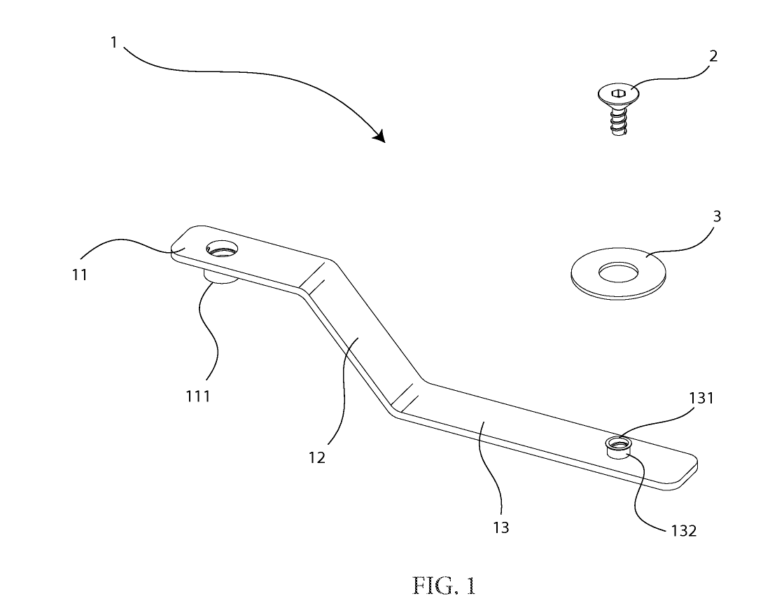

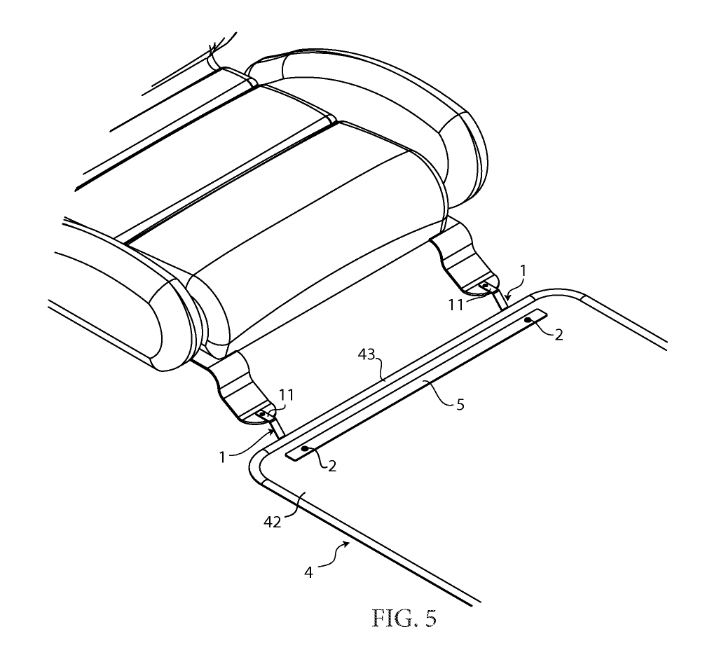

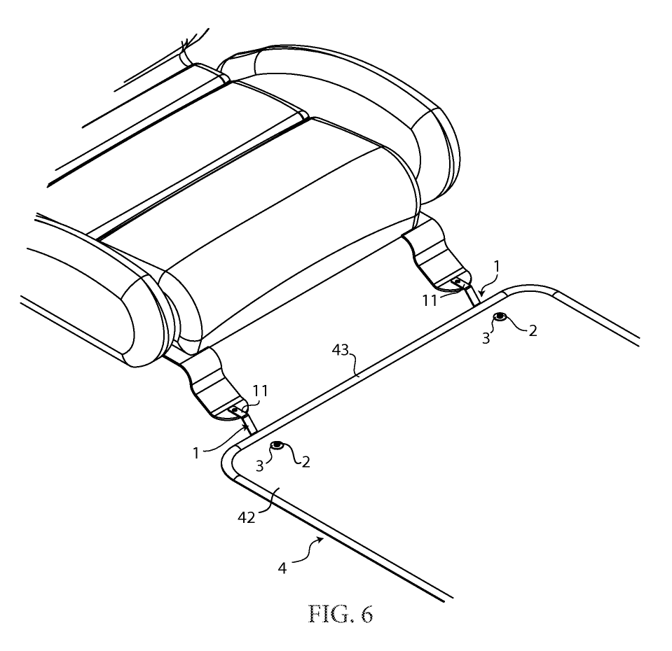

In reference to FIG. 1-3 and FIG. 5-6, the present invention is a securing system that comprises of a bracket 1, a threaded bolt 2, a mat washer 3, and a mat 4. The mat of the present invention comprises of at least one hole 41, a carpet top 42, and a rear edge 43. The at least one hole 41 are positioned adjacent to the rear edge 43 of the mat 4. In the preferred embodiment of the present invention, the mat 4 has two holes 41 corresponding to the two seat tracks under most cars. The bracket 1 is a customized molded steel or reinforced plastic compound bracket 1 that is form fitted to have a raised portion 11, an angled portion 12, and a lower mat portion. For each mat in a car, two of the brackets 1 will be used. These brackets 1 are attached to each of the mounting ears on each side of the driver's and/or passenger's seat track. The raised portion 11 of the brackets 1 comprises of a mounting ear hole 111 that bolts to each of the mounting ears by the existing bolts that are already attached to the mounting ears of the seat tracks. The raised portion 11 of the bracket 1 is connected to the lower mat mounting portion 13 by means of the angled portion 12. The angled portion 12 is angled from the raised portion 11. The raised portion 11 is positioned in parallel relationship to the lower mat mounting portion 13. The raised portion 11 being extended to fit the form of the mounting ear of the seat track comprises of a mounting ear hole 111 end. The mounting ear hole 111 end is the end of the bracket 1 where the raised portion 11 will overlap the mounting ear. The mounting ear hole 111 is positioned on the mounting ear hole 111 end.

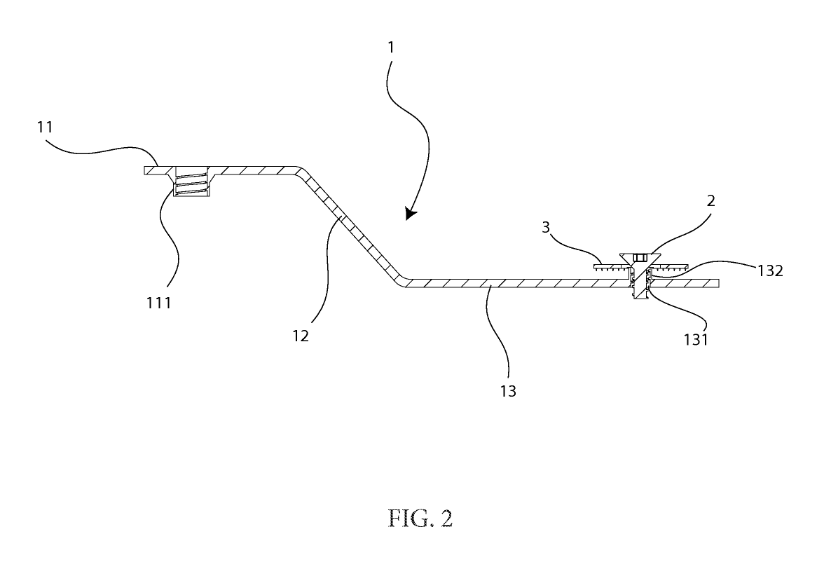

In reference to FIG. 2, the lower mat mounting portion 13 is the portion of the bracket 1 that will engage and secure the floor mat. The lower mat mounting portion 13 comprises of a threaded hole 131 and a stud 132. The lower mat mounting portion 13 is extended to reach under the floor mat for a secure spot to mount and comprises of a mat end. The mat end is the end of the bracket 1 that reaches under the floor mat. The threaded hole 131 is positioned on the mat end of the lower mat mounting portion 13. The stud 132 of the lower mat mounting portion 13 is a protrusion that is peripherally protruding from the threaded hole 131. The stud 132 protruding from the lower mat mounting bracket 1 will protrude through the holes in the floor mat to provide a tight fit. The threaded bolt 2 is the inserted through the mat washer 3 and engages the threaded hole 131. The mat washer 3 being positioned between the threaded bolt 2 and the lower mat mounting portion 13 ensures the floor mat is fully secured to the bracket 1. The threaded bolt 2 can be any type of fastener including a hexagon, torque, Phillips or Allen bolt to be engaged to the threaded hole 131 for securely holding the floor mats without possibility of slippage. In the preferred embodiment of the present invention, the threaded bolt 2 and the mat washer 3 will have a plurality of spikes 31 that are designed to grip the floor mat carpet top 42 and prevent the threaded bolts 2 from loosening.

To install the present invention onto a car, the user will first remove the existing mounting ear bolts that are attached to the mounting ear studs located on each side of the driver's or passenger's seat track. The bracket 1 of the present invention will be engaged to the mounting ear studs by the mounting ear hole 111. The user will then secure the mounting ear bolts back onto the mounting ear studs to fasten the bracket 1 onto the seat tracks. Once the user has secured the bracket 1 onto the car, the floor mat is then placed over the stud 132 of each bracket 1. With the stud 132 inserted through each hole of the floor mat, the user will then secure the floor mat to the bracket 1 by securing the threaded bolt 2 and the mat washer 3 to the stud 132. The same process can be done with any shaped hole bracket 1.

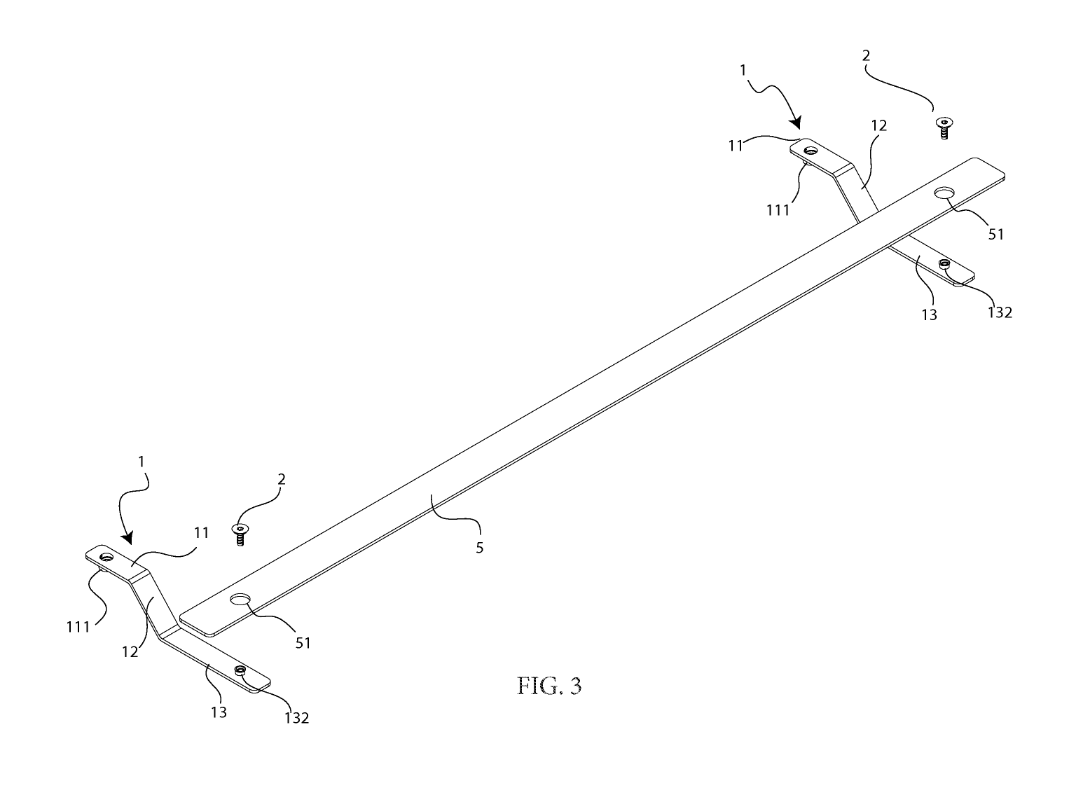

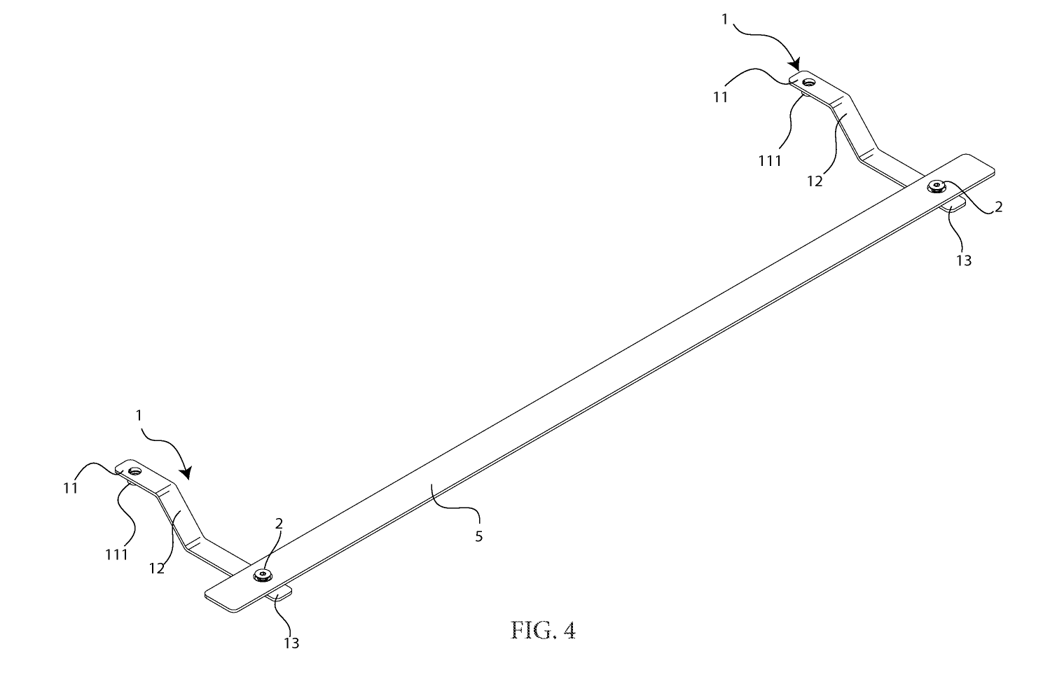

In another embodiment of the present invention, additional custom steel or reinforced plastic compound molded studs components can be attached to the bracket 1 for other mounting purposes. Such components can be mounted under the mounting ears, hidden under the carpet and mounted under the mounting ears, hidden under the carpet and mounted over the mounting ears, or mounted to the floor frame with a male or female threaded stud to protrude to the top of the floor mats. In reference to FIG. 3-5, in another embodiment of the present invention, the present invention can additionally comprise of a horizontal fastening bar 5. The horizontal fastening bar 5 comprises of a pair of holes 51 that is fastened to the lower mat mounting portion 13 on between the mat washer 3 and the carpet top 42. The horizontal fastening bar 5 serves to additionally stabilize the mat 4.

Although the invention has been explained in relation to its preferred embodiment, it is to be understood that many other possible modifications and variations can be made without departing from the spirit and scope of the invention as hereinafter claimed.

What is claimed is:

1. A car mat locking apparatus comprises,
a bracket;
a threaded bolt;
a mat washer;
a mat;
the bracket comprises of a raised portion, an angled portion, and a lower mat mounting portion;
the mat comprises of at least one hole, a carpet top, and a rear edge;
the at least one hole being positioned adjacent to the rear edge;
the raised portion being connected to the lower mat mounting portion by the angled portion;
the raised portion being in parallel relationship to the lower mat mounting portion; and
the angled portion being angled in relationship to the raised portion.

2. The car mat locking apparatus as claimed in claim 1 comprises,
the raised portion comprises of a mounting ear hole;
the raised portion being extended and having a mounting ear hole end; and
the mounting ear hole being positioned on the mounting ear hole end.

3. The car mat locking apparatus as claimed in claim 1 comprises,
the lower mat mounting portion comprises of a threaded hole;
the lower mat mounting portion being extended and having a mat end; and
the threaded hole being positioned on the mat end of the lower mat mounting portion.

4. The car mat locking apparatus as claimed in claim 3 comprises,
the threaded bolt being inserted through the mat washer and engaging the threaded hole; and
the mat washer being positioned between the threaded bolt and the lower mat mounting portion.

5. The car mat locking apparatus as claimed in claim 3 comprises,
the lower mat mounting portion comprises of a stud; and
the stud being peripherally protruding from the threaded hole.

6. The car mat locking apparatus as claimed in claim 5 comprises,
the bracket being connected to the mat by means of the stud;
the stud being inserted through the at least one hole of the mat;
the mat washer comprises of a plurality of spikes; and
the plurality of spikes engaging the carpet top to prevent the threaded bolt from loosening.

7. The car mat locking apparatus as claimed in claim 6 comprises,
a horizontal fastening bar; and
the horizontal fastening bar being secured between the carpet top and the mat washer.

8. A car mat locking apparatus comprises,
a bracket;
a threaded bolt;
a mat washer;
a mat;
the bracket comprises of a raised portion, an angled portion, and a lower mat mounting portion;
the mat comprises of at least one hole, a carpet top, and a rear edge;
the at least one hole being positioned adjacent to the rear edge;
the raised portion being connected to the lower mat mounting portion by the angled portion;
the raised portion being in parallel relationship to the lower mat mounting portion;
the angled portion being angled in relationship to the raised portion.
the raised portion comprises of a mounting ear hole;
the raised portion being extended and having a mounting ear hole end;
the mounting ear hole being positioned on the mounting ear hole end;
the lower mat mounting portion comprises of a threaded hole;
the lower mat mounting portion being extended and having a mat end; and
the threaded hole being positioned on the mat end of the lower mat mounting portion.

9. The car mat locking apparatus as claimed in claim 8 comprises,
the threaded bolt being inserted through the mat washer and engaging the threaded hole; and
the mat washer being positioned between the threaded bolt and the lower mat mounting portion.

10. The car mat locking apparatus as claimed in claim 8 comprises,
the lower mat mounting portion comprises of a stud; and
the stud being peripherally protruding from the threaded hole.

11. The car mat locking apparatus as claimed in claim 10 comprises,
the bracket being connected to the mat by means of the stud;
the stud being inserted through the at least one hole of the mat;
the mat washer comprises of a plurality of spikes; and
the plurality of spikes engaging the carpet top to prevent the threaded bolt from loosening.

12. The car mat locking apparatus as claimed in claim 11 comprises,
a horizontal fastening bar; and
the horizontal fastening bar being secured between the carpet top and the mat washer.

13. A car mat locking apparatus comprises,
a bracket;
a threaded bolt;
a mat washer;
a mat;
the bracket comprises of a raised portion, an angled portion, and a lower mat mounting portion;
the mat comprises of at least one hole, a carpet top, and a rear edge;
the at least one hole being positioned adjacent to the rear edge;
the raised portion being connected to the lower mat mounting portion by the angled portion;
the raised portion being in parallel relationship to the lower mat mounting portion;
the angled portion being angled in relationship to the raised portion. the raised portion comprises of a mounting ear hole;
the raised portion being extended and having a mounting ear hole end;
the mounting ear hole being positioned on the mounting ear hole end;
the lower mat mounting portion comprises of a threaded hole;
the lower mat mounting portion being extended and having a mat end;
the threaded hole being positioned on the mat end of the lower mat mounting portion;
the bracket being connected to the mat by means of the stud;
the stud being inserted through the at least one hole of the mat;
the lower mat mounting portion comprises of a stud; and
the stud being peripherally protruding from the threaded hole.

14. The car mat locking apparatus as claimed in claim 13 comprises,
the threaded bolt being inserted through the mat washer and engaging the threaded hole; and
the mat washer being positioned between the threaded bolt and the lower mat mounting portion.

15. The car mat locking apparatus as claimed in claim 13 comprises,
the mat washer comprises of a plurality of spikes; and
the plurality of spikes engaging the carpet top to prevent the threaded bolt from loosening.

16. The car mat locking apparatus as claimed in claim 15 comprises,
a horizontal fastening bar; and
the horizontal fastening bar being secured between the carpet top and the mat washer.
